(19) United States
(12) Patent Application Publication
(10) Pub. No.: US 2016/0117643 A1
(43) Pub. Date: Apr. 28, 2016

(54) COMMUNITY SERVICE TRACKING AND VERIFICATION SYTEM

(71) Applicant: Todd Bittle, Bellevue, WA (US)

(72) Inventor: Todd Bittle, Bellevue, WA (US)

(21) Appl. No.: 14/506,781

(22) Filed: Oct. 6, 2014

(51) Int. Cl. G06Q 10/10

(52) U.S. Cl. CPC G06Q 10/1091

(57) ABSTRACT

A community service tracking and verification system that allows users to use computers and the Internet to track and verify the completion of community service hours served. Internet connectivity is established between a plurality of volunteer computers and a plurality of service opportunity provider computers. As a volunteer completes his service hours, the total number of hours completed is logged into the system. This information is verified for accuracy by the service opportunity provider computer. In a preferred embodiment an official transcript showing the completion of verified service hours can be printed out as needed.

The present invention relates to tracking and verification systems, and in particular, to tracking and verification systems using utilizing the Internet to track and verify work completed.

### BACKGROUND OF THE INVENTION

In modern society individuals are frequently in competition to gain acceptance at either a new job or at an education institution. For the potential employer or college admissions board, it is sometimes difficult to compare individuals when deciding on admissions. For example, when evaluating a pool of applicants a college admissions board will compare high school grades and SAT scores. However, in many cases this information alone is not enough to make the best decision. College admission boards are also very much interested in the individual and his personality. The board wants to know how the person has contributed to his community. Community service hours are important. A high number of hours demonstrates that a person cares about his community and wants to work to make it better. This translates to a well rounded person and increases the odds of success in college.

Potential students are very aware of the importance of having completed significant volunteer hours. Unfortunately, students sometimes may be tempted to bend the truth or falsify community service hours completed to increase their odds of admission to a college. This is a big problem with today's system. It is very difficult to accurately verify community service hours served and admissions boards are sometimes forced to take the applicant at his word for his claims of hours served.

What is needed is a better system for tracking and verifying community hours served.

### SUMMARY OF THE INVENTION

The present invention provides a community service tracking and verification system that allows users to use computers and the Internet to track and verify the completion of community service hours served. Internet connectivity is established between a plurality of volunteer computers and a plurality of service opportunity provider computers. As a volunteer completes his service hours, the total number of hours completed is logged into the system. This information is verified for accuracy by the service opportunity provider computer. In a preferred embodiment an official transcript showing the completion of verified service hours can be printed out as needed.

### BRIEF DESCRIPTION OF THE DRAWINGS

FIGS. 1-20 show a preferred embodiment of the present invention.

FIGS. 21-23 show another preferred embodiment of the present invention.

FIG. 24 shows a preferred Internet connectivity.

### DETAILED DESCRIPTION OF THE PREFERRED EMBODIMENTS

In a preferred embodiment of the present invention a website allows community service volunteers searching for potential opportunities to: 1) find available opportunities, 2) complete the community service hours, 3) document the completed hours, and 4) validate the completed hours. Organizations looking to find volunteers can also access the website and upload the opportunity to the website. The website also allows for the creation of an official transcript that shows validated hours completed. This official transcript can then be presented as part of an admissions packet to show verified hours completed to the admissions offices at colleges and universities.

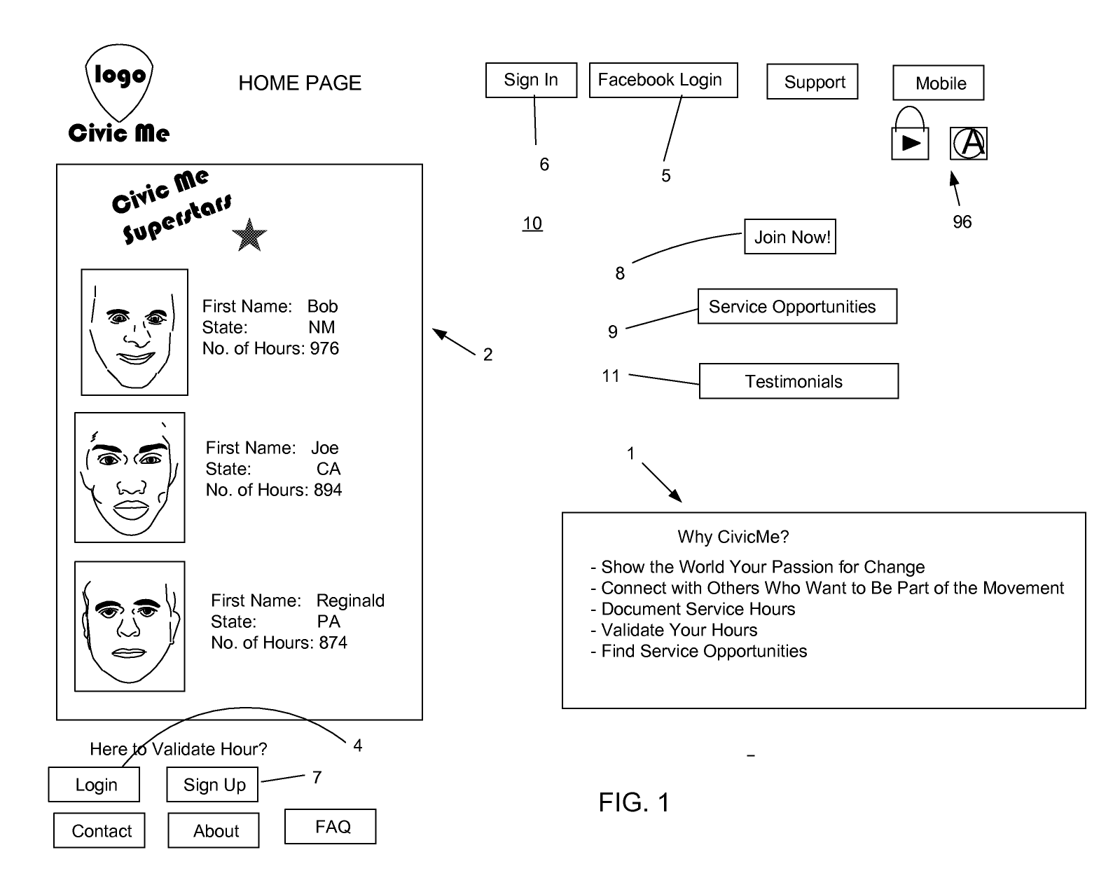

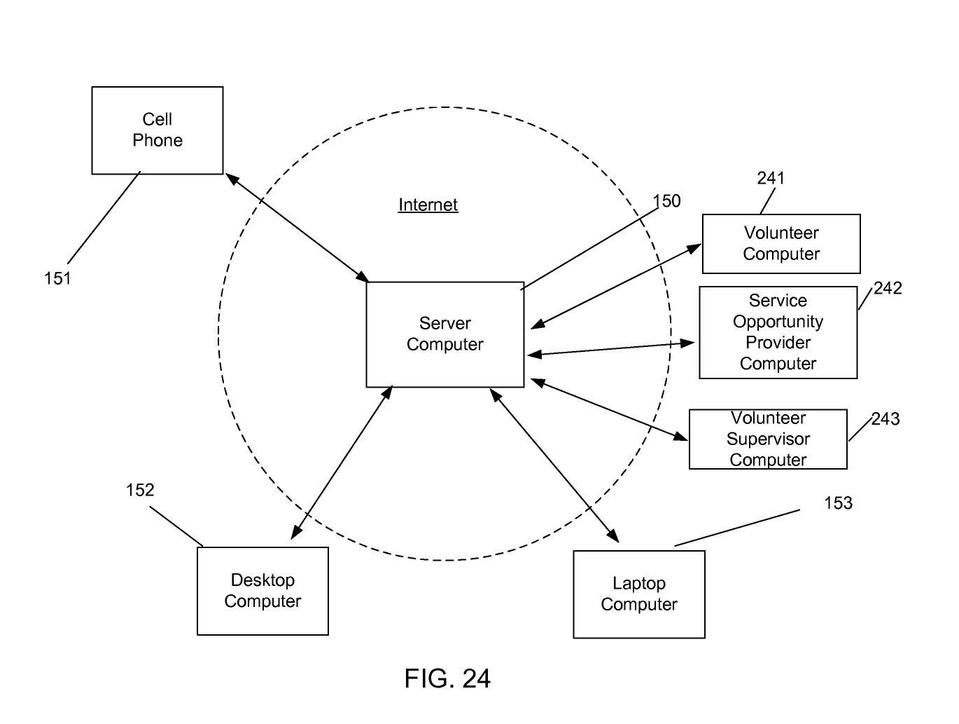

In a preferred embodiment of the present invention a website is accessed via a computer network by utilization of personal computing devices. In a preferred embodiment the computer network is the Internet. A variety of computing devices may be used, including: a cell phone, a desktop computer, and a laptop computer. The website is preferably programmed onto a server computer. Data is stored on the server computer 150 (FIG. 24) and may be downloaded onto the personal computing devices 151-153. The server computer and computing devices 151-153 include software and computer programming adapted to permit the functions discussed below in reference to FIGS. 1-24.

FIG. 1 shows a home page 10 of a preferred website programmed onto server computer 151. In a preferred embodiment of the present invention the website is referred to as CivicMe™. Explanation section 1 provides a list of reasons why an individual or company may want to join CivicMe™. Motivation section 2 provides a listing of individuals who have recorded a very high number of volunteer hours. A purpose of section 2 is to motivate others to join website after seeing the success of high performers. At home page 10 the website user can login by clicking on buttons 4, 5 or 6. Or a new website user can join by clicking on buttons 7 or 8. Service opportunities can be researched by clicking on button 9 and testimonials can be reviewed by clicking on button 10.

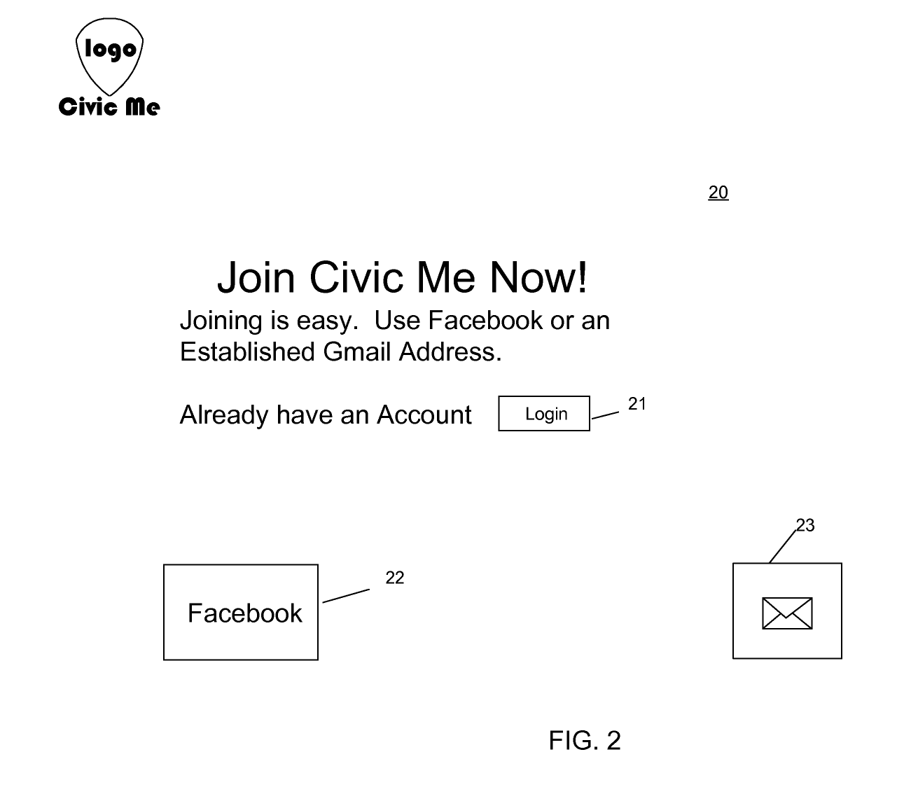

If the website user clicks on buttons 7 or 8 to sign up or join, he will be directed to web page 20 shown in FIG. 2. If the user is already registered, he can click on button 21 to login. Otherwise the user can click on button 22 to join using his Facebook® account or click on button 23 to join using his email address.

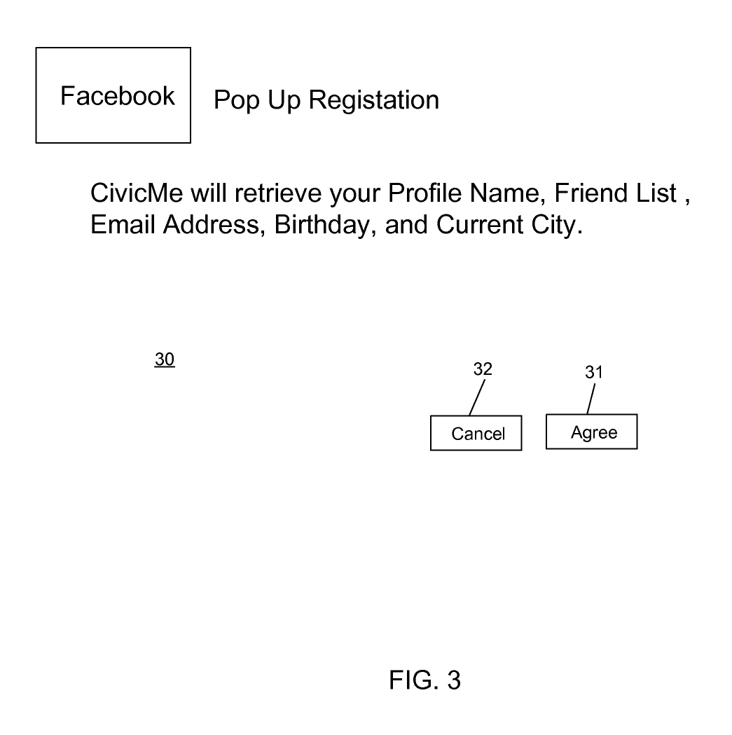

If the user clicks on button 22 he will be directed to website page 30 shown in FIG. 3. If the user agrees to the Facebook® registration terms, then he should click on button 31. If he disagrees, he should click on button 32.

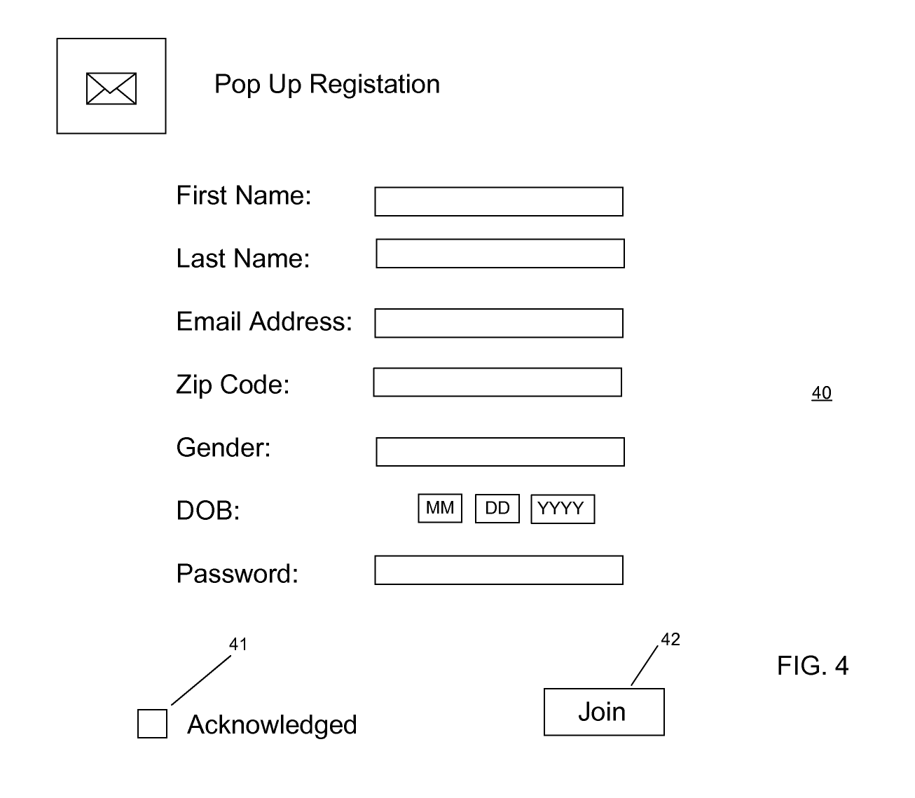

If the user clicks on button 23 (FIG. 2) he will be directed to website page 40 shown in FIG. 4. To register the user enters the appropriate personal identification data into the boxes shown. If his entries are correct the user clicks on acknowledgement box 41. The user then clicks button 42 to join.

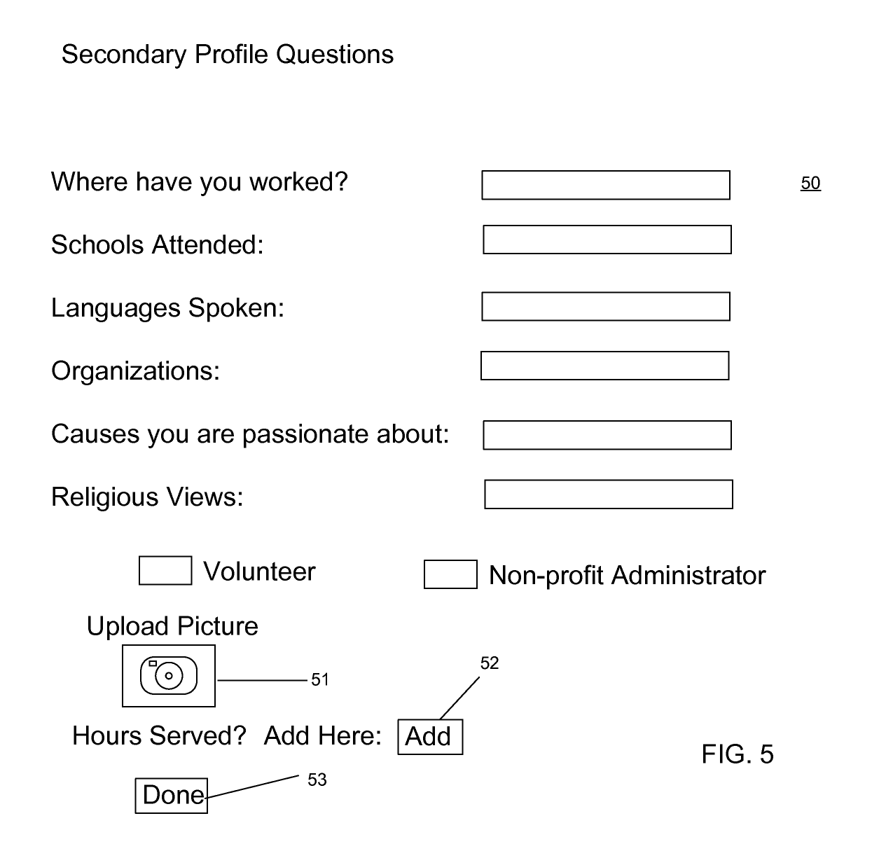

After clicking button 31 (FIG. 3) or button 42 (FIG. 4) the user will be directed to page 50 (FIG. 5). Here the user can enter more detailed personal identification data and then checks if he is a “Volunteer” and/or a “Non-profit Adminstrator”. The user can then upload his picture by clicking on button 51. The user can add completed community service hours by clicking on button 52. After the user is done with his entries, he can leave page 50 by clicking on button 53.

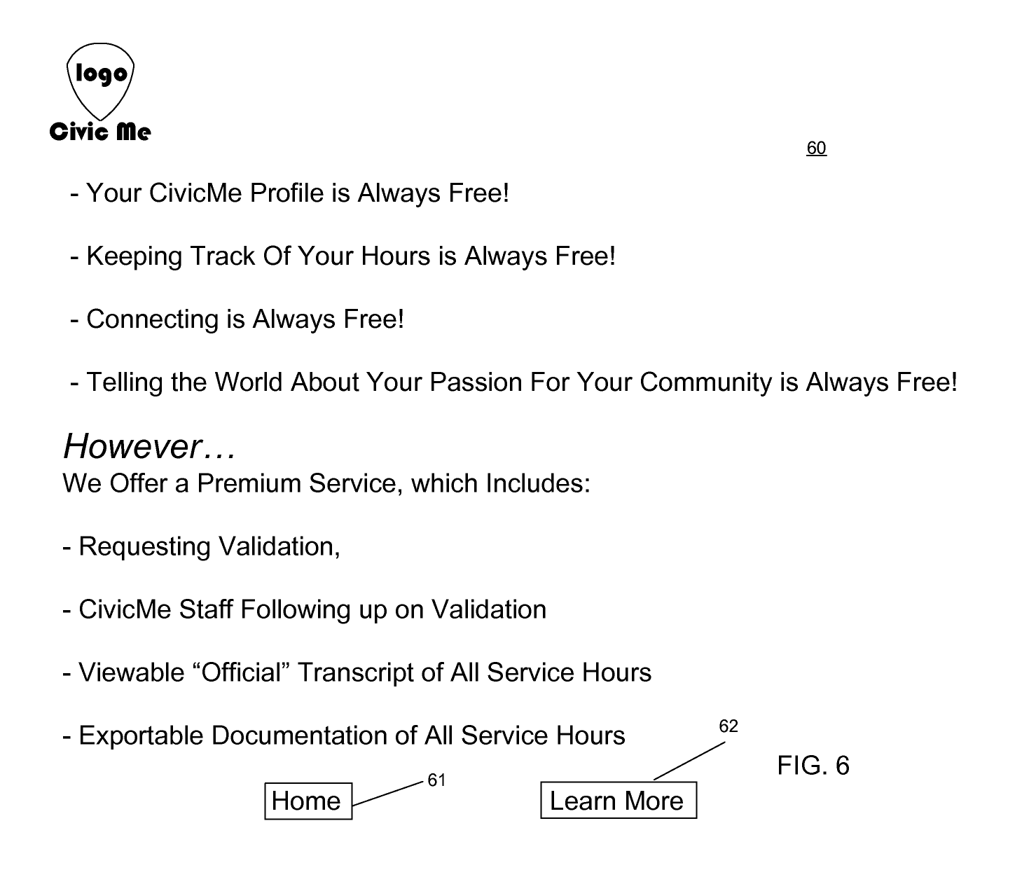

After clicking button 53 (FIG. 5)) the user will be directed to page 60 (FIG. 6.). Here some of the features of the free website service are listed. Also the user is shown the features of a premium pay service. The user clicks on button 62 to learn more about the pay service or clicks on button 61 to return to the home page.

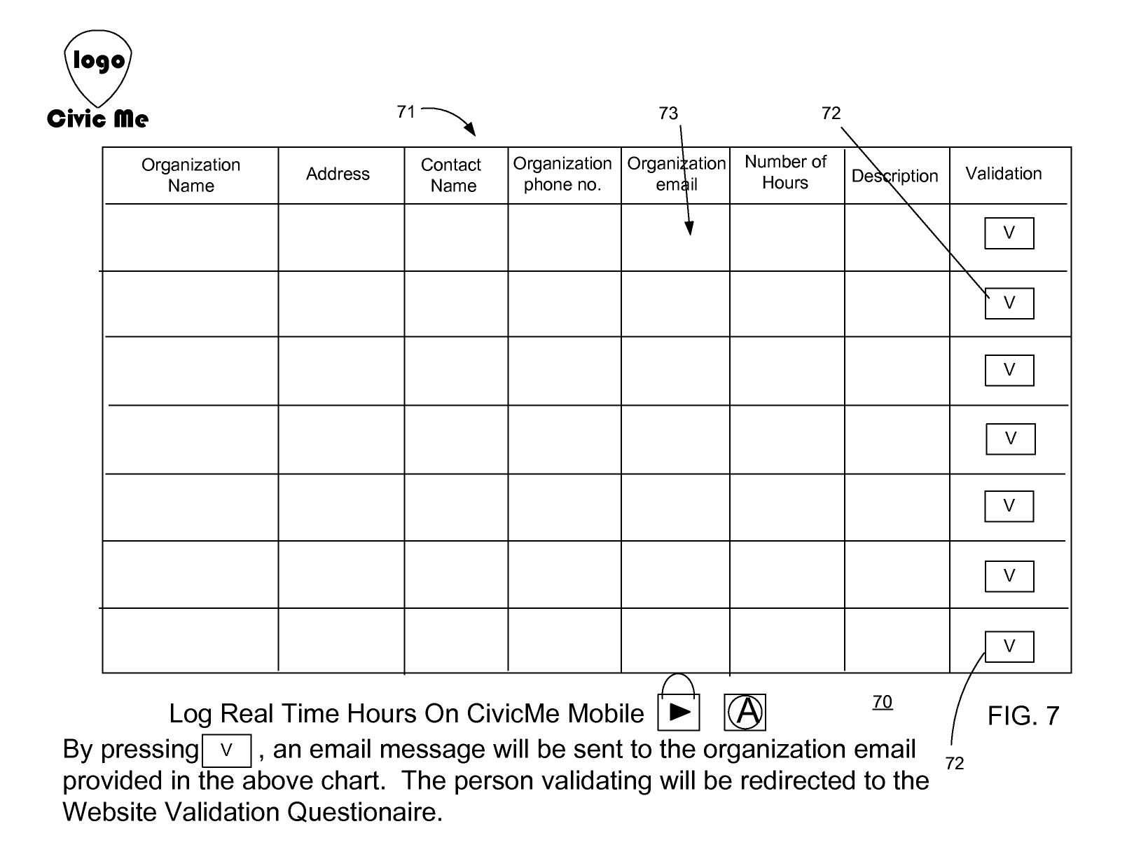

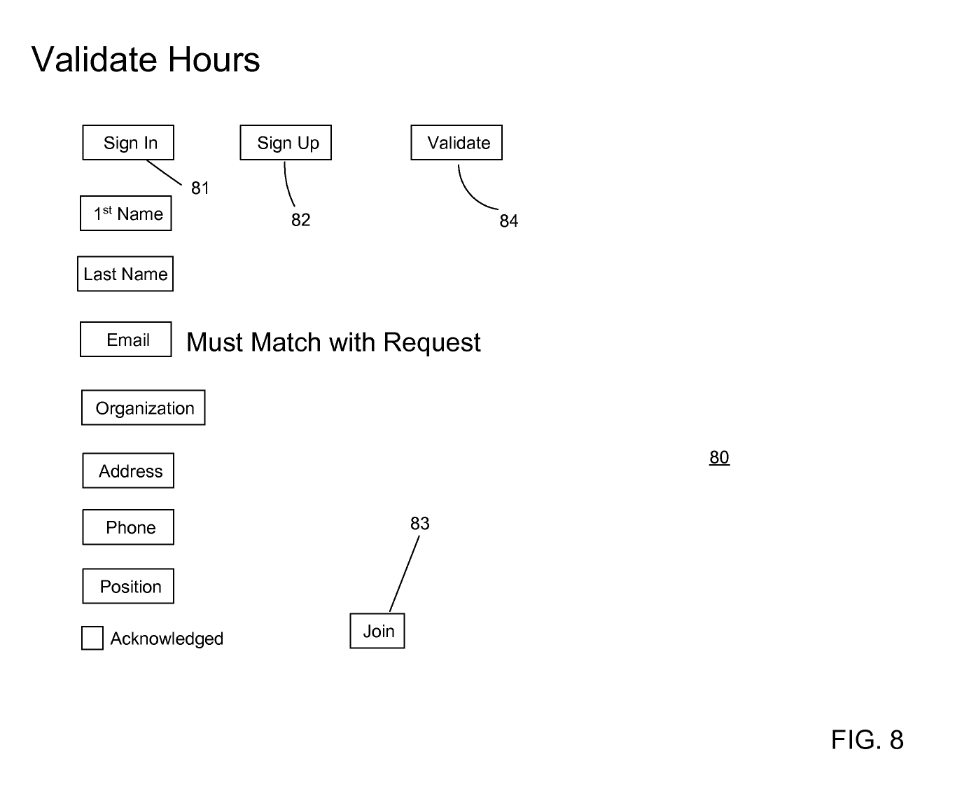

After clicking button 52 (FIG. 5) the user will be directed to page 70 (FIG. 7). The user will then enter the number of hours completed for each organization as appropriate. He will also enter identifying information for each organization. To validate each entry the user will click on button 72. An email will then be sent to the email address 73 provided for the organization. A contact person at the organization will receive the email. The email will contain a link that the contact person will click on. The link will direct the contact person to hours validation page 80 (FIG. 8).

FIG. 8 shows hours validation page 80. The contact person enters indentifying information including his name, the organization name and his email address. The email address must match email address 73 (FIG. 7). If already a member of CivicMe® website, then the contact person can sign in by clicking button 81. If not yet a member the contact person can join by clicking buttons 82 or 83. To proceed with the validation process the contact person clicks on button 84.

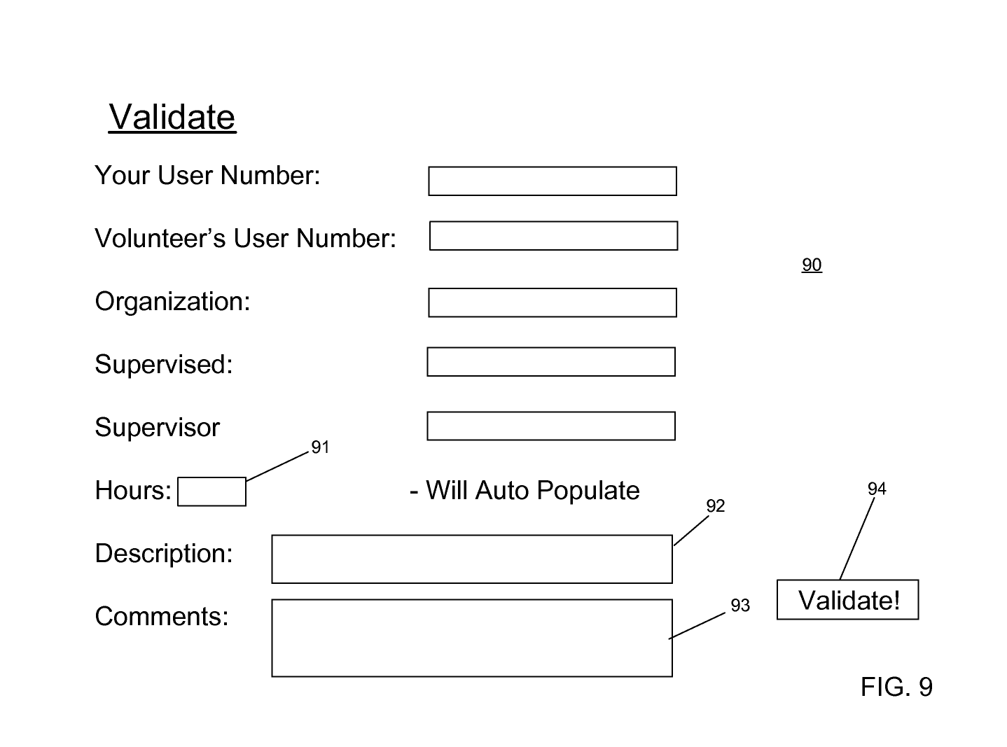

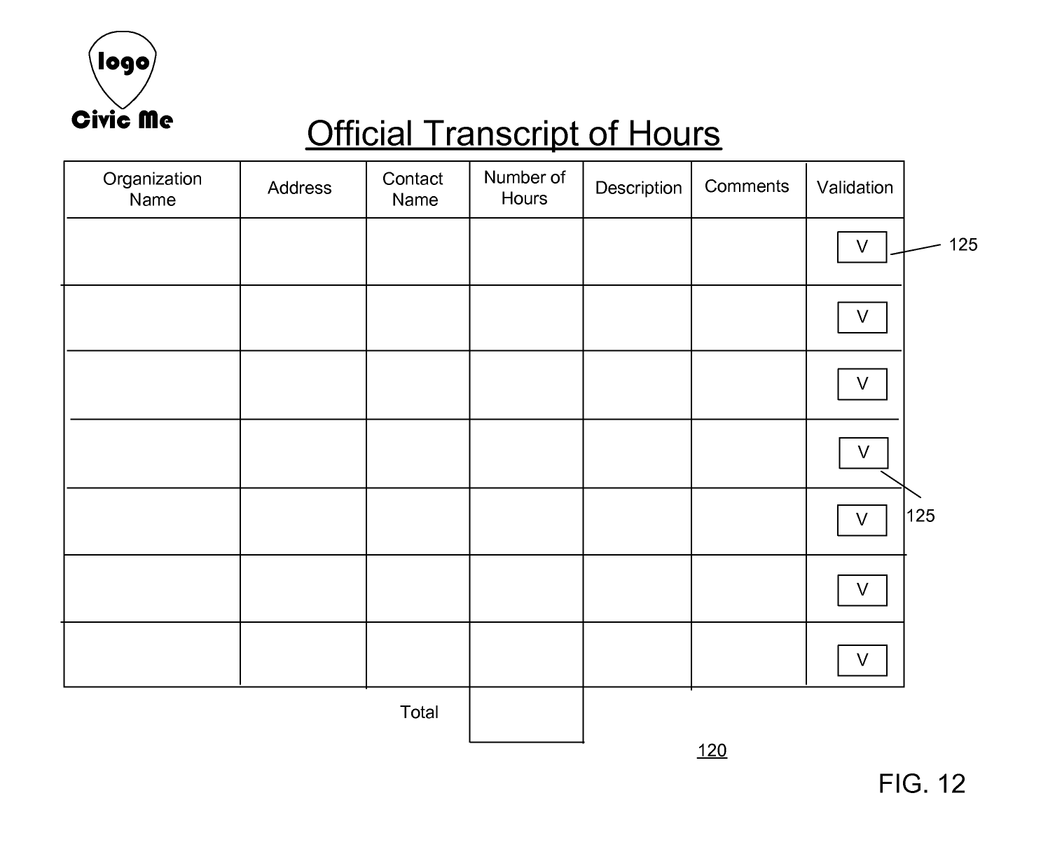

After clicking button 84 (FIG. 8) the contact person will be directed to page 90 (FIG. 9). Here the contact person will enter his identifying information in the spaces provided. The contact person will also enter the number of hours completed in space 91. The contact person may also enter additional information in description space 92 and comments space 93. To finish the validation process the contact person will click on button 94. After clicking on button 94 the user's hours have been validated. This information can be then provided as official certificate 123 (FIG. 12) and given as proof that hours were completed and validated. Validated hours 125 are indicated as shown and can be provided as proof that volunteer hours were completed and then validated by the organization. Also see further discussion below in reference to FIG. 12.

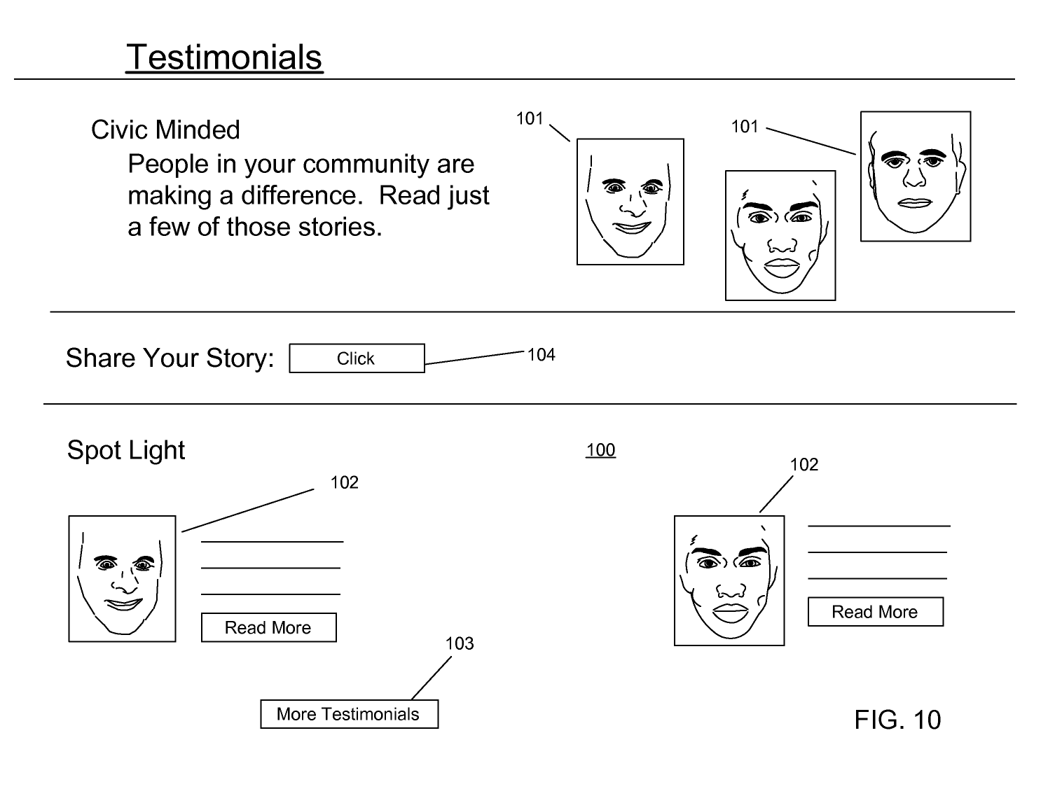

After clicking button 11 (FIG. 1) the user will be directed to page 100 (FIG. 10). A user visiting home page 10 may view testimonials of current website members. A user can read testimonials by clicking on images 101 or spot lighted images 102. The user can view additional testimonials by clicking on button 103. A registered member can enter his own testimonial by clicking on button 104.

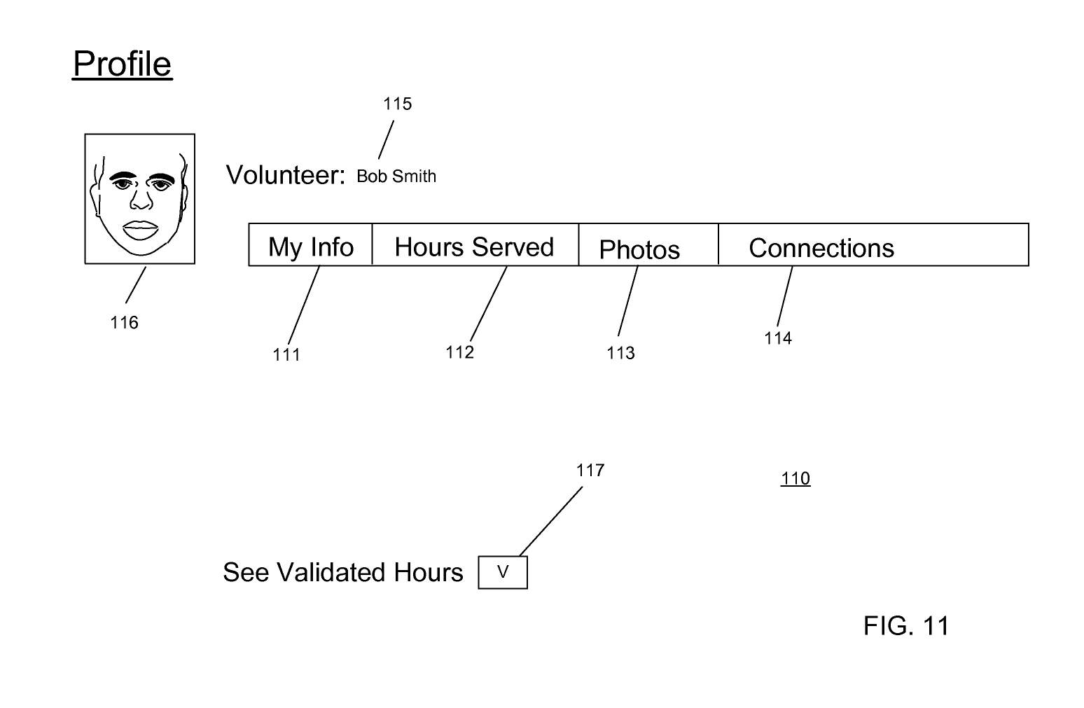

After clicking buttons 101 or 102 (FIG. 8) the user will be directed to page 110 (FIG. 11) corresponding to the individual chosen on page 100 of FIG. 10. Here the profile of an individual member can be viewed. The volunteer's (i.e., the person who has completed community service work hours) picture 116 is displayed as well as his name 115. The user can learn more about the volunteer by clicking on buttons 111-114. To view a chart showing the volunteers validated hours the user clicks on button 117.

After clicking button 117 (FIG. 11) the user will be directed to page 120 (FIG. 12). The user can view chart 121 which is an official transcript of validated hours completed by the volunteer. Validated hours 125 are indicated as shown and can be provided as proof that volunteer hours were completed and then validated by the organization.

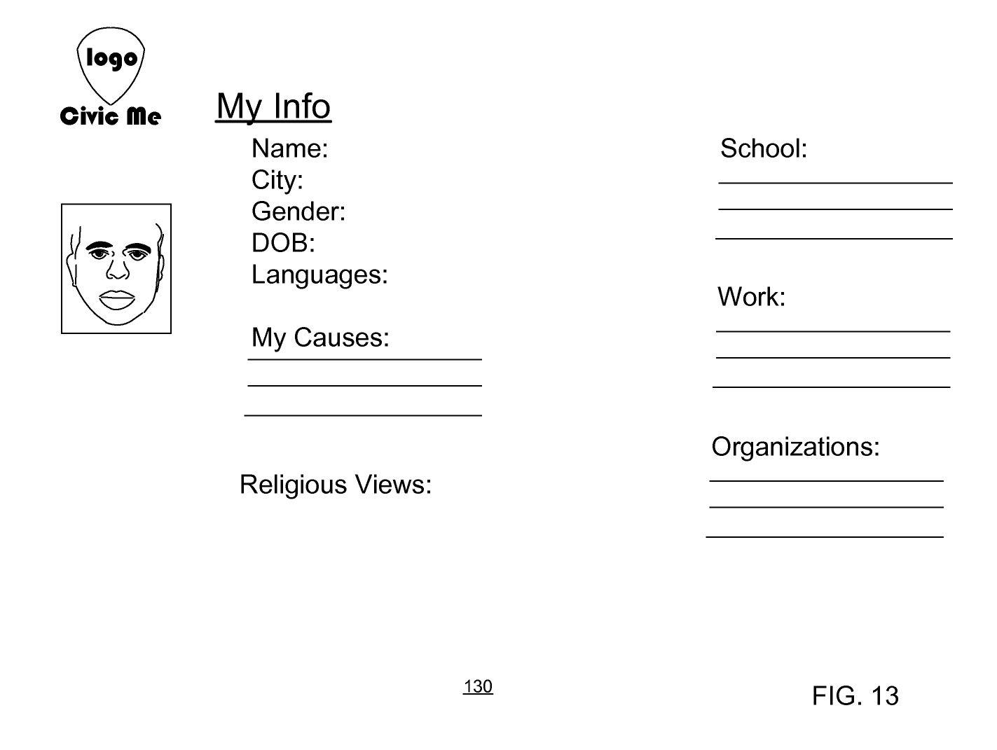

After clicking button 111 (FIG. 11) the user will be directed to page 130 (FIG. 13). Here the user can view identifying information about the volunteer.

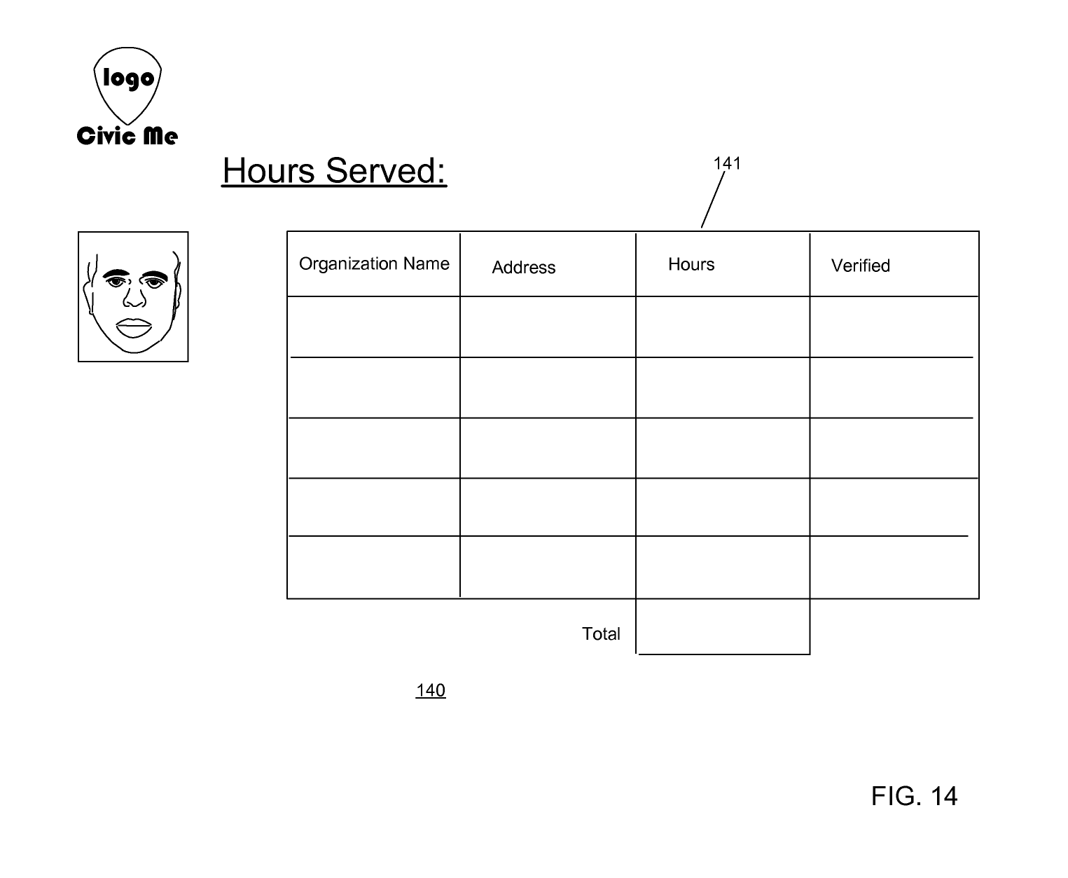

After clicking button 112 (FIG. 11) the user will be directed to page 140 (FIG. 14). Here the user can view shortened summary chart 141 that succinctly displays hours of community service completed for specific organizations. Verification information is also displayed.

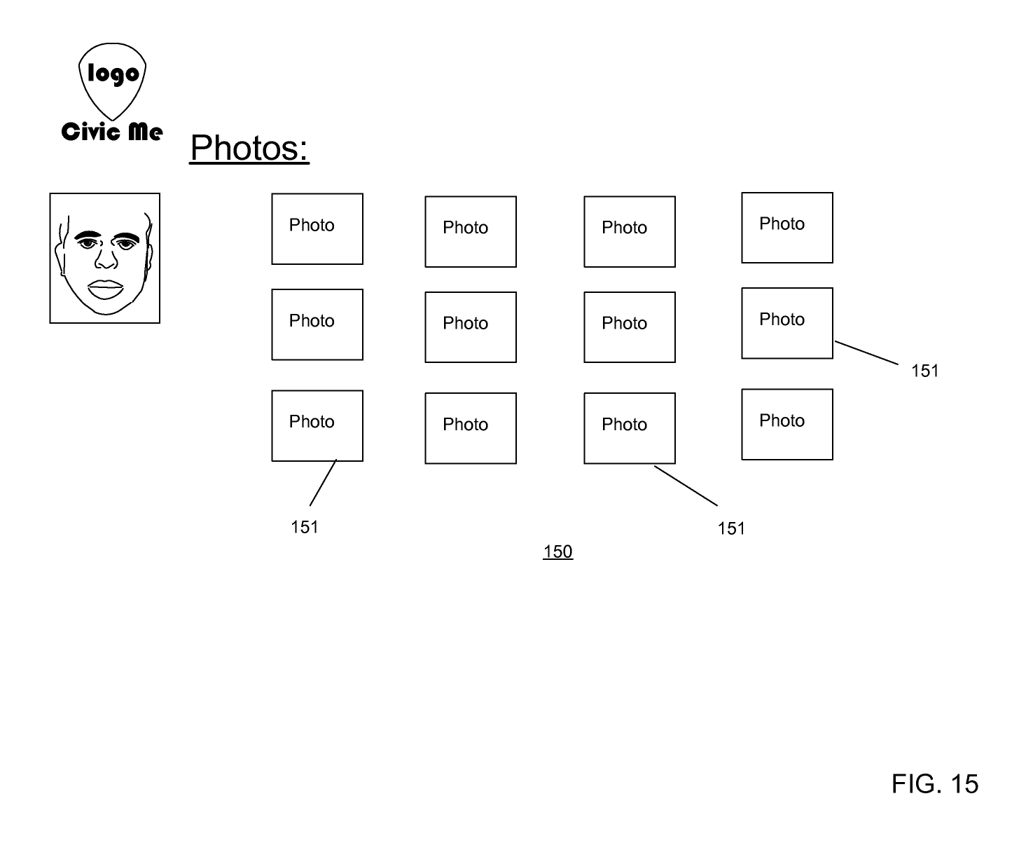

After clicking button 113 (FIG. 11) the user will be directed to page 150 (FIG. 15). Here the user can view photos of the volunteer in action while completing volunteer hours for community service.

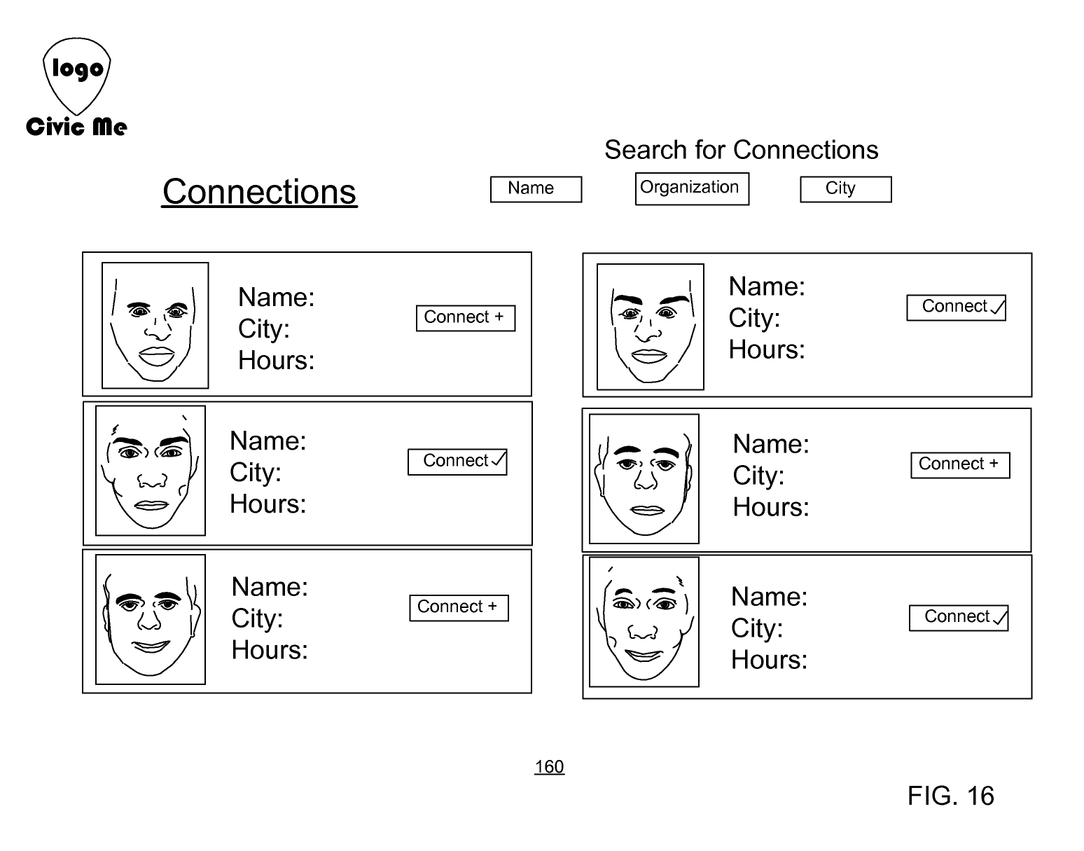

After clicking button 114 (FIG. 11) the user will be directed to page 160 (FIG. 16). Here the user can view connections and potential connections that the volunteer may have. These connections are preferably also registered members at CivicMe®. At page 160 it is also possible to search for additional user connections. The search criteria can be by volunteer name, organization name, or volunteer city.

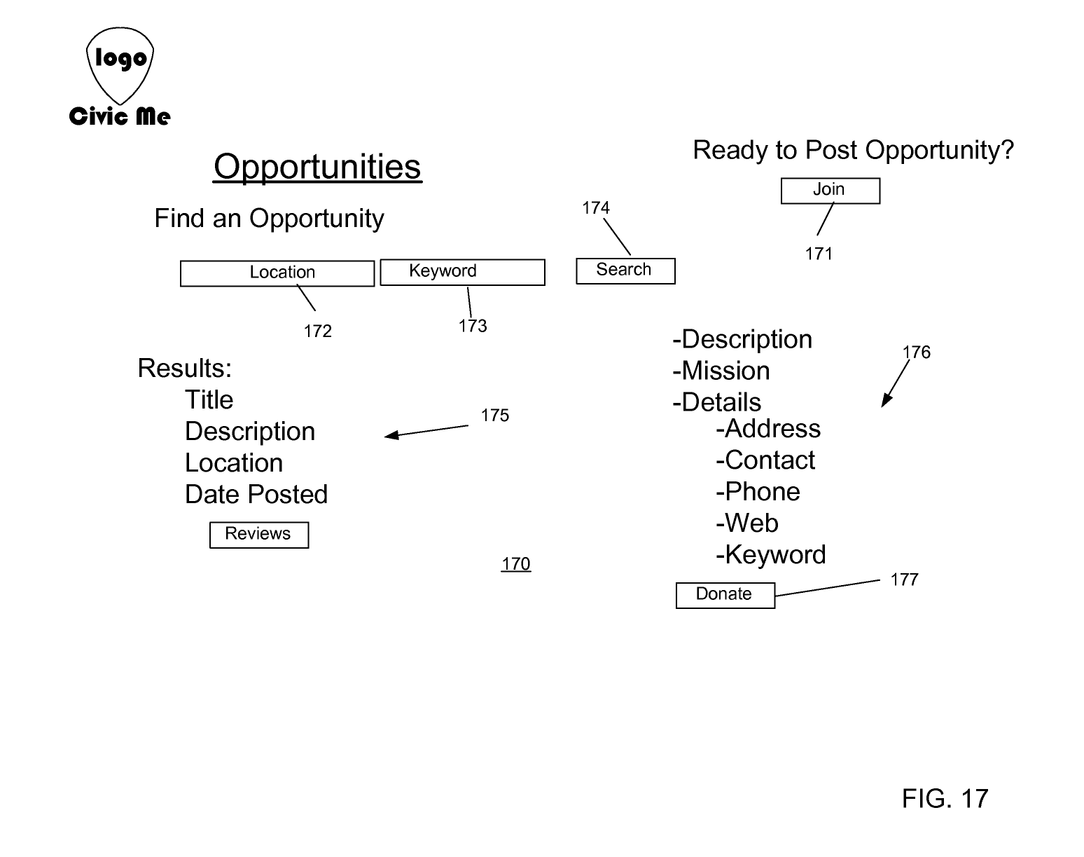

After clicking button 9 (FIG. 1) the user will be directed to page 170 (FIG. 17). Here an opportunity provider has the ability to post a community service opportunity that can be viewed by potential volunteers. To post the opportunity the opportunity provider can click on button 171. Also a volunteer can search for potential opportunities by entering search terms in spaces 172 and 173 and then clicking on button 174. The results of the search are displayed at results section 175. Further information about the opportunity is displayed at section 176. To donate money to the organization a volunteer can click on button 177. This will transfer the volunteer to the organization website.

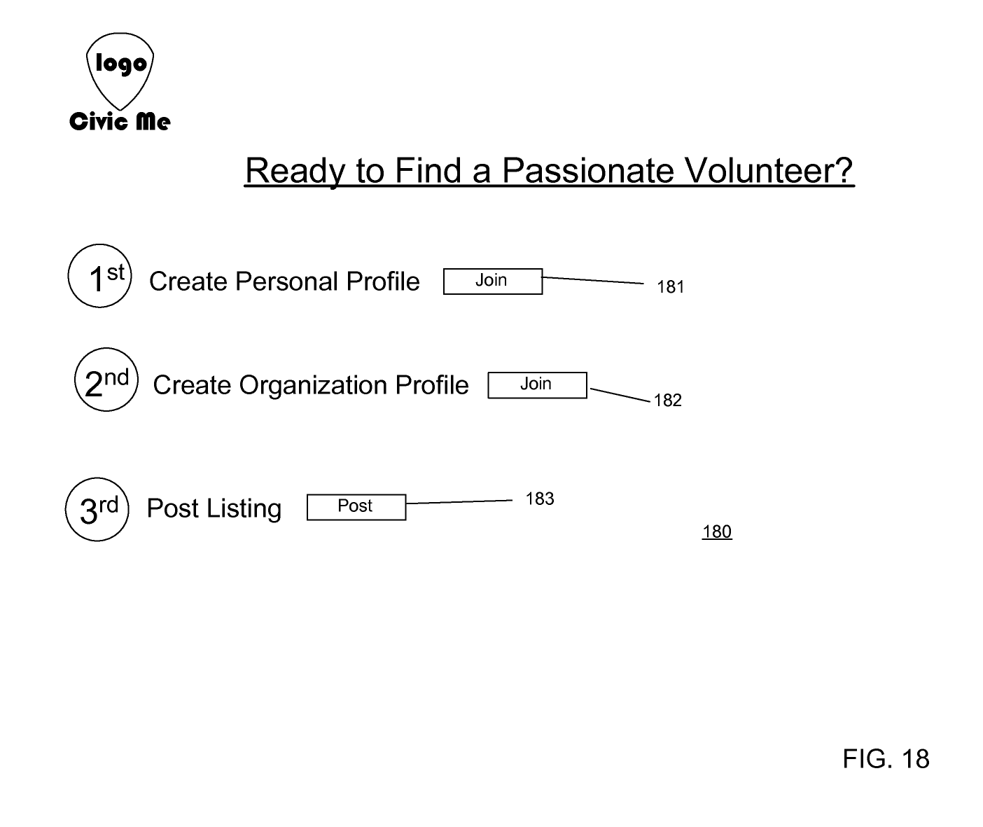

After clicking button 181 (FIG. 18) the user will be directed to page 40 (FIG. 4). An individual can register and join by clicking on button 181. See above discussion for details of page 40.

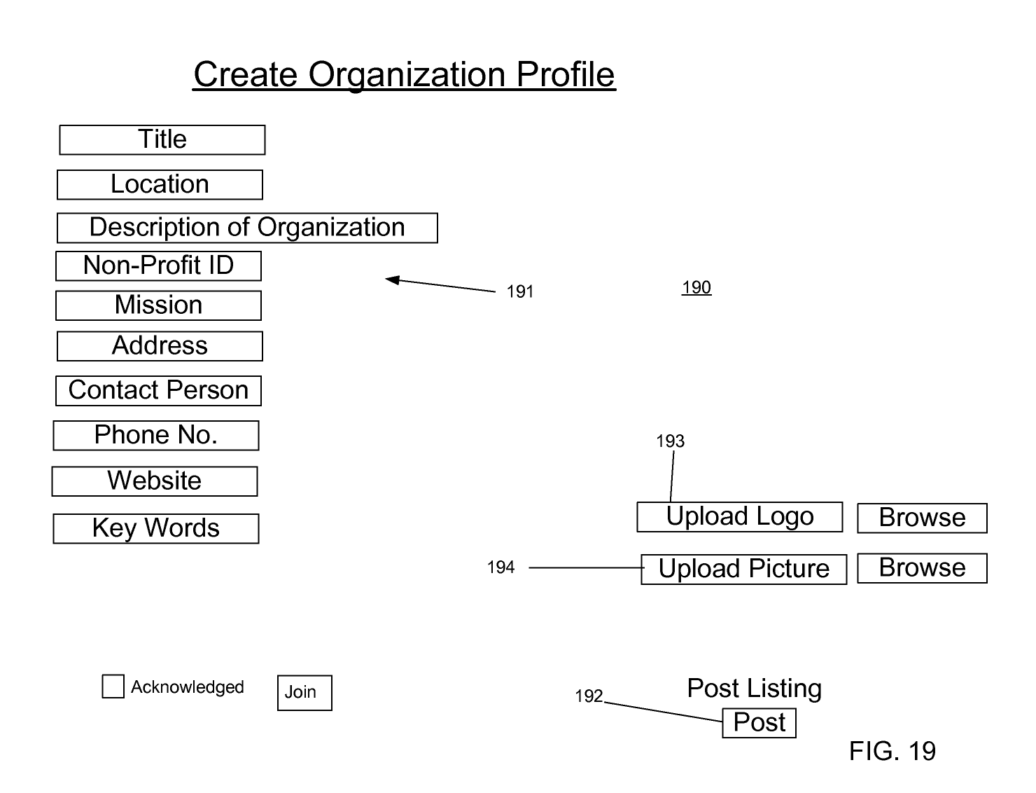

After clicking button 182 (FIG. 18) the user will be directed to page 190 (FIG. 19). Here the organization can enter indentifying information into the appropriate spaces at section 191. The organization can also upload an image of their logo and upload an organization picture by clicking on buttons 193 and 194. After the identifying information has been entered the user can click on button 192 to proceed with posting an opportunity.

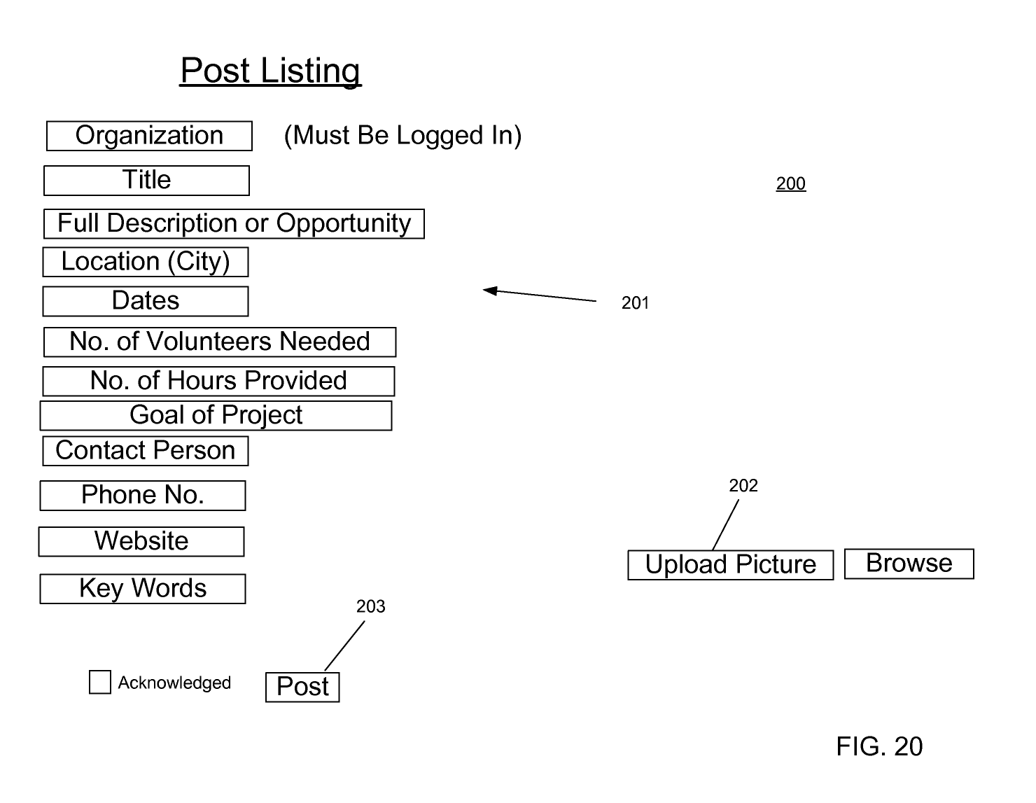

After clicking buttons 183 (FIG. 18) or 192 (FIG. 19) the user will be directed to page 200 (FIG. 20). Here the organization can enter opportunity descriptive information into the appropriate spaces at section 201. The organization can also upload an image of their opportunity by clicking on button 202. After the descriptive information has been entered the user can click on button 203 to post the opportunity listing.

### Other Preferred Embodiment

### Mobile Application

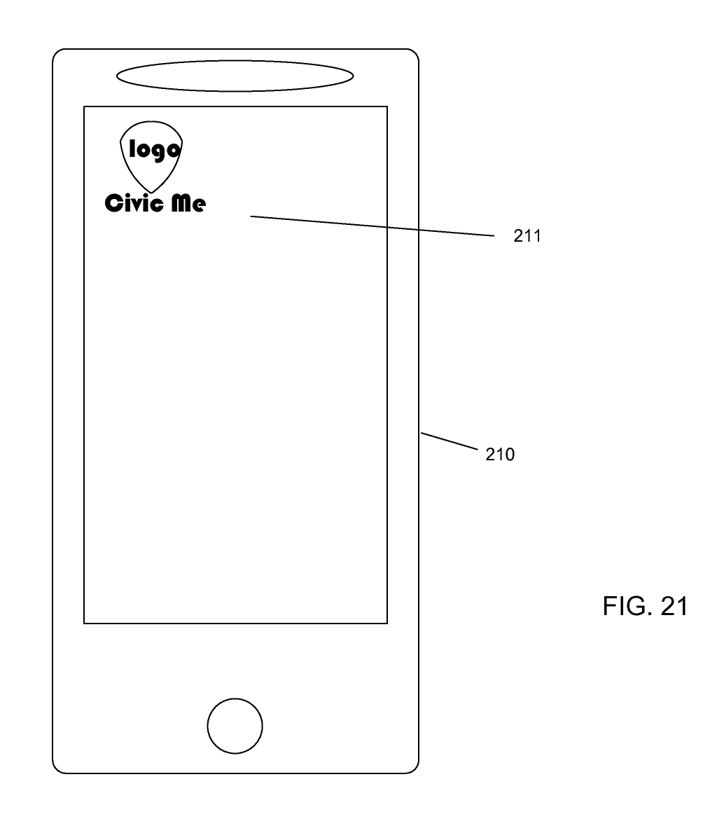

FIG. 21 shows cell phone 210 programmed to display software app 211. Software app 211 includes features similar to those described above. In one preferred embodiment the user uses the internet browser on his cell phone to access the webpages described above. In another preferred embodiment, the user downloads a separate software app that includes features similar to those described above and shown in FIGS. 1-20. Preferably, webpage 10 (FIG. 1) includes autopopulate mobile feature 96 which allows mobile input to automatically load into multiple computing devices displaying the profile utilized on webpages 10-200.

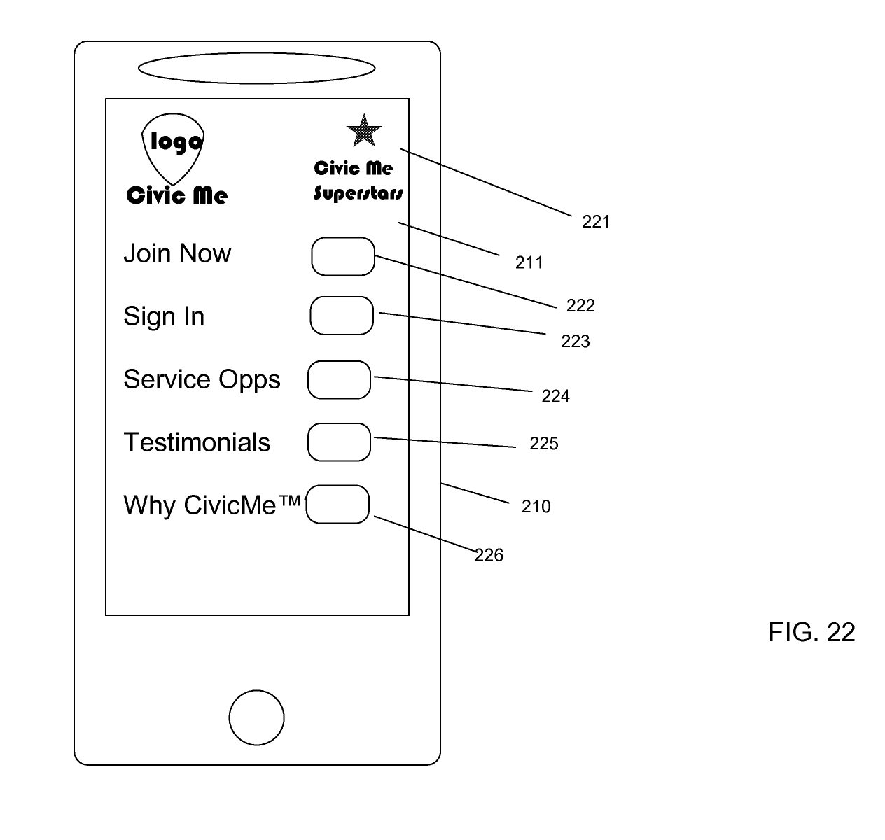

FIG. 22 shows cell phone 210 with app 211 loaded. The user presses image 221 to bring up motivation section 2, as shown in FIG. 1. The user presses button 222 to bring up page 2 (FIG. 20). The user presses button 223 to enter his identifying information and sign in. The user presses button 224 to bring up page 170 (FIG. 17). The user presses button 225 to bring up page 100 (FIG. 10). The user presses button 226 to bring up explanation section 1 (FIG. 1).

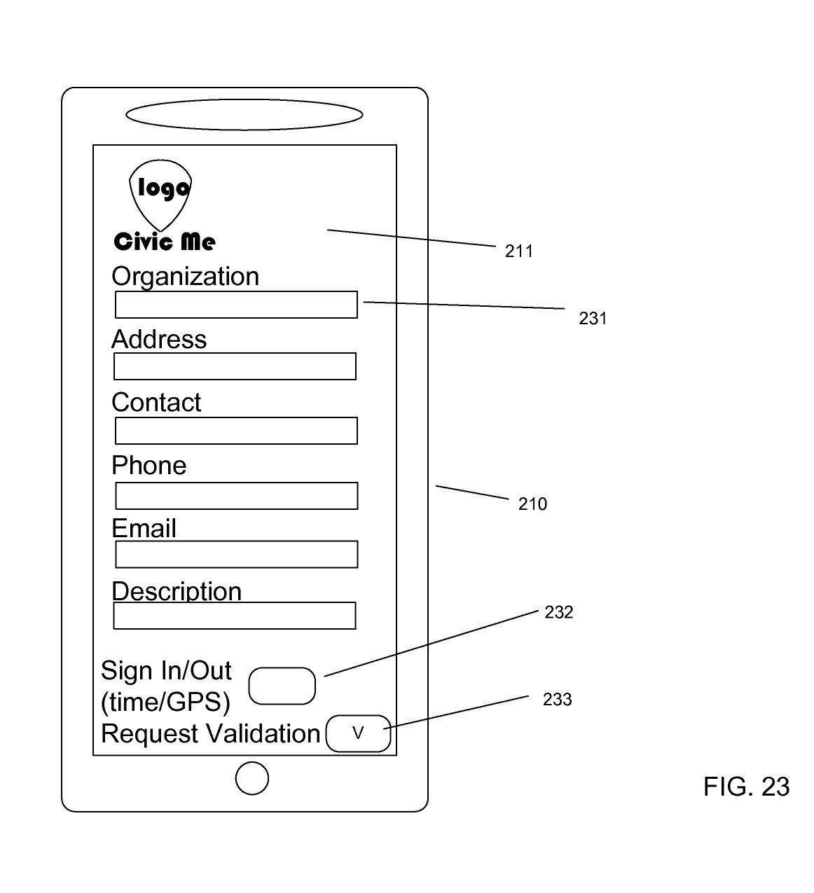

FIG. 23 shows cell phone 210 with another page of app 211 loaded. The user inputs the organization name into space 231. In a preferred embodiment this input and further inputs automatically autopopulate the data regarding the community service performed. When the user is onsite and beginning his community service hours, the user preferably presses on button 232. This will automatically keep time of the hours completed. Also, in a preferred embodiment, when the user presses on button 232 his GPS coordinates are recorded in addition to starting his time clock running. When the user is finished with his community service, he should press on button 232 again. This will stop the time tracked and it will also again record his GPS coordinates. The total time completed and the volunteer's GPS location at the start of his hours and at the end of his hours is automatically updated to the volunteer's profile. Therefore, there is a computer data record that documents and records that the volunteer was completing his hours for a specific length of time at a specific location. The volunteer can then immediately send a request to validate his hours and location by pressing on button 233. An email will then be sent to the email address 73 (FIG. 7) provided for the organization. A contact person at the organization will receive the email. The email will contain a link that the contact person will click on. The link will direct the contact person to hours validation page 80 (FIG. 8). The contact person will validate the hours completed in a fashion similar to that described above.

### Connectivity

FIG. 24 shows preferred connectivity for utilization of the present invention. The website depicted in FIGS. 1-23 can be accessed by a variety of computing devices with Internet connectivity. In a preferred embodiment, the above described website is housed on server computer 150. Server computer 150 can be accessed via cell phone 151, desktop computer 152 or laptop computer 153. Data is preferably stored on server computer 150 as well as on computers 151-153. Volunteers (using volunteer computers 241) are in communication via the Internet with service opportunity providers (using service opportunity provider computers 242).

### Volunteer Supervisors

In a preferred embodiment it is possible to organize multiple volunteers into one or more groups. Preferably, a supervisor is in charge of the group. The supervisor preferably has access to some or all of the web pages discussed above so that the supervisor can adequately ensure that the volunteers are achieving a minimum number of hours. For example, in one preferred embodiment a supervisor operating volunteer supervisor computer 243 (FIG. 24) is in Internet connectivity with multiple volunteers operating volunteer computers 241. The supervisor has access to view the Official Transcript of Hours (FIG. 12) for each volunteer. Therefore, the supervisor is able to ensure that the minimum number of hours has been achieved for each volunteer in his group.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

What is claimed is:

1. A community service tracking system providing for the utilization of the Internet to permit tracking and verification of hours served, comprising:
A. a server computer comprising software adapted to permit Internet communication between a plurality of volunteers and a plurality of service opportunity providers,
B. a plurality of volunteer computers operated by volunteers completing community service hours, each of said volunteer computers comprising software adapted to permit Internet communication,
C. a plurality of service opportunity provider computers, each of said service opportunity provider computers comprising software adapted to permit Internet communication, wherein said volunteer computers are in Internet communication with said plurality of service opportunity provider computers,
wherein service hours completed by said volunteers are verified by said service opportunity providers via the Internet.

2. The system as in claim 1 wherein said system further comprises software adapted to permit the uploading of service opportunities from said service opportunity provider computers.

3. The system as in claim 1 wherein said system further comprises software adapted to permit validation of volunteer service hours, wherein said validation is completed by said service opportunity provider at said service opportunity provider computer.

4. The system as in claim 1 wherein said system further comprises software adapted to permit a creation of a viewable official transcript of all service hours completed.

5. The system as in claim 1 wherein said system further comprises software adapted to permit auto population of data entered via a hand held remote computing device.

6. The system as in claim 6 wherein said hand held remote computing device is a cell phone.

7. The system as in claim 1 wherein said plurality of volunteer computers and said plurality of service provider opportunity computers comprises laptop computers, desktop computers, and cell phones.

8. The system as in claim 1 wherein said system further comprises software adapted to permit the entry and review of testimonials.

9. The system as in claim 1 wherein said system further comprises software adapted to permit the making of connections with multiple volunteers and service opportunity providers.

10. The system as in claim 1 wherein said system further comprises software adapted to permit the searching of available service opportunities via a keyword search.

11. The system as in claim 1 wherein said system further comprises software adapted to permit the searching of available service opportunities via a location search.

12. The system as in claim 1 wherein said system further comprises software adapted to permit the entry and upload of a service opportunity provider profile.

13. The system as in claim 1 wherein said system further comprises software adapted to permit the entry and upload of a description of a service opportunity.

14. The system as in claim 1 wherein said system further comprises software adapted to permit the entry and upload of a volunteer profile.

15. The system as in claim 1 wherein said system further comprises software adapted to permit a volunteer to:
A. press on at least one button to start time and location for beginning of hours served,
B. press on said at least one button to end time and location for end of hours served, and
C. press on another button to send a request for validation of total completed hours.

16. The system as in claim 1, further comprising at least one volunteer supervisor computer comprising software adapted to permit Internet communication between said plurality of volunteers and a supervisor of said plurality of volunteers to form a supervised volunteer group.
